(19) United States
(12) Patent Application Publication
(10) Pub. No.: US 2007/0119227 A1
(43) Pub. Date: May 31, 2007

(54) Reference volume tube

(76) Inventor: Fukuo Moriyama, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/581,605

(22) PCT Filed: Jul. 22, 2004
(86) PCT No.: PCT/JP04/10782

§ 371 Date: Oct. 3, 2006

(30) Foreign Application Priority Data
Dec. 25, 2003 (JP) 2003-428602

(51) Int. Cl. G01F 25/00

(52) U.S. Cl. 73/1.16; 73/1.18

(57) ABSTRACT

A reference volume tube (10) which is a bi-directional prover having a prover pipe (12) provided with two detectors (14a, 14b), and tube sections (16a, 16b) provided at the opposite ends. At each position of the tube sections (16a, 16b) closer to the detector (14a, 14b), waiting means (18a, 18b) consisting of gates (20a, 20b) and hydraulic cylinders (22a, 22b) are provided. When a sphere (24) is positioned at the tube section (16b), a gate (20b) of the waiting means (18b) provided between the sphere (24) and the detector (14b) projects into the tube section (16b). Consequently, the sphere (24) moved from the tube section (16b) toward the detector (14b) is stopped by the waiting means (18b) until the flow velocity of a fluid reaches a specified value and prevented from moving in the direction to the detector (14b), and the sphere (24) waits at that position.

### TECHNICAL FIELD

The present invention relates to a reference volume tube which calibrates a flow meter to be tested based on a reference volume indicated through movement of a moving element by a predetermined section in a measurement tube portion having a reference volume, and more exactly, based on the volume of a fluid discharged when the moving element moves by the predetermined section and substantially equal to the reference volume.

### BACKGROUND ART

It is obligatory for a meter to undergo calibration after each fixed period of time to check (test) whether or not the metering precision is within a fixed range.

One of the flow meter calibration (testing) methods uses a reference volume tube as a calibration device.

In this method, a measurement tube portion (volume tube or prover pipe) having a volume serving as a reference (hereinafter referred to as reference volume) and a flow meter constituting an object of calibration (hereinafter referred to as flow meter to be tested) are connected in series, and calibration is performed on the flowmeter to be tested based on the volume of a fluid discharged when a moving element moves by a predetermined section in the measurement tube portion and substantially equal to the reference volume. Here, assuming that an instrumental error is E, the volume (flow rate) measured by the flow meter to be tested is I, and the reference volume of the reference volume tube is Q, E is obtained as follows: E=(I−Q)/Q×100(%).

Reference volume tubes can be roughly classified into unidirectional provers and bidirectional provers.

In a method using the former, i.e., a unidirectional prover, the measurement tube portion is formed as a loop tube or a straight tube, and two detectors are provided at both ends of the measurement tube portion. Inserted into the measurement tube portion is the moving element, such as a highly elastic ball (hereinafter referred to as sphere) whose diameter is approximately 2 to 4% larger than an inner diameter of the measurement tube portion, or a piston. Through movement of the moving element in one direction between the two detectors, testing is effected on the flow meter to be tested. When the test is to be repeatedly conducted, after completion of one test, the moving element, which has reached to a terminal end of the measurement tube portion, is returned to a start end of the measurement tube portion for the next test. This can be effected manually or by connecting the terminal end and the start end of the measurement tube portion for automatic circulation (see, for example, JP 2931149 B, JP 11-304572 A, and “Chapter 4, Section 2 of Petroleum Measurement Standard Manual” (issued by American Petroleum Institute on June, 1988)).

In a method using the latter, i.e., a bidirectional prover, an apparatus of substantially the same construction as that of the unidirectional prover is used. After the moving element has moved in one direction between two detectors, the flow path is switched by a valve or the like, causing the moving element to move in the opposite direction (see, for example, “Chapter 4, Section 2 of Petroleum Measurement Standard Manual” (issued by the American Petroleum Institute on June, 1988)).

To achieve a high level of accuracy, a reference volume tube whose measurement tube portion is formed as a straight tube requires a measurement tube portion having a length dimension that is, for example, twice as large as that of a reference volume tube whose measurement tube portion is formed as a loop tube. To avoid this problem, there is also used a small volume compact prover reduced in reference volume by pulse interpolation and made small enough to be portable. Such a small volume compact prover may also be regarded as a reference volume tube in a broad sense.

A conventional unidirectional prover (hereinafter simply referred to as reference volume tube) will be further described with reference to FIG. 1.

A reference volume tube 1a is equipped with a prover pipe 2a having a reference volume. The reference volume is determined beforehand through precise measurement of the volume of the section between a first detector 6a and a second detector 7a. A fluid having passed through a flow meter to be tested (not shown) connected to an inlet tube 3a, flows from the inlet tube 3a to an outlet tube 4a via the prover pipe 2a. Here, calibration is effected based on the volume of the fluid discharged when a sphere 5a moves within the prover pipe 2a through the section from the first detector 6a to the second detector 7a. That is, the volume of the fluid discharged when the sphere Sa moves through the above section, is substantially equal to the reference volume which is indicated owing to the movement of the sphere 5 through the section. By comparing this reference volume with the indication value (volume) of the flow meter to be tested, calibration is effected.

The reference volume tube 1a adopts a method in which the sphere 5 is automatically circulated, and is equipped with a passage portion 8 for extracting the sphere 5a that has completed the section movement from the terminal end of the prover pipe 2a to release it at the start end of the prover pipe 2a.

The passage portion 8 is provided with valves 8a, 8b and a relay portion 8c for keeping the sphere 5a on standby between the valves 8a, 8b. Reference symbol 8d indicates a sphere lock member control device.

At the time of measurement, the fluid is previously caused to circulate through the prover pipe 2a, and a steady state is maintained so that a predetermined flow velocity of approximately 3 m/secas recommended, for example, in American Petroleum Institute (API) Standard, can be achieved in a stable manner (see, for example, “Chapter 4, Section 2 of Petroleum Measurement Standard Manual” (issued by the American Petroleum Institute on June, 1988)).

Subsequently, the valve 8a is closed, and the valve 8b is opened to release the sphere 5a into the stable flow of the fluid in the prover pipe 2a.

As a result, it is possible to conduct test and calibrating operation with high accuracy. According to the American Petroleum Institute Standard, inclusive of the case of a bidirectional prover described below, the reproducibility at the time of calibration should be ±0.01%. According to the Japanese Measurement Law, an accuracy of 1/3,000 to 1/5,000 is required. Thus, both standards require a high level of accuracy.

Next, a conventional bidirectional prover (hereinafter simply referred to as reference volume tube) will be further described with reference to FIG. 2.

Like the reference volume tube 1a, which is a unidirectional prover, a reference volume tube 1b is equipped with a prover pipe 2b having a reference volume. The prover pipe 2b is equipped with two detectors 6b, 7b. At both ends of the prover pipe 2b, there are respectively provided tube sections (header portions) 9a, 9b whose diameter is larger than that of the prover pipe 2b.

Normally, dimensions of the prover pipe 2b are determined as follows.

The reference volume is determined to be approximately 0.5% or more of the maximum test flow rate (per unit time). On the other hand, the flow velocity of the fluid, in other words, the moving speed of the sphere, is set to approximately 1.5 m/sec, which is lower than that of the unidirectional prover described above. Through the determination of these two values, the pipe diameter of the prover pipe is determined of necessity.

For example, when the maximum test flow rate is 2,000³/H, the reference volume is approximately 10 m³, and the pipe diameter (diameter) of the prover pipe is approximately 0.69 m. The distance between the two detectors corresponding to the reference volume at this time is approximately 27 m.

In the reference volume tube 1b, fluid tubes 3b, 4b and the two tube sections 9a, 9b are connected to one another by a four-way valve 9c so as to allow switching of flow passage.

Prior to the measurement, a flow meter to be tested (not shown) is attached to one of the fluid tubes 3b, 4b.

Then, the four-way valve 9c is operated to switch the flowing direction of the fluid. For example, communication is established between the fluid tube 3b to which the flow meter to be tested is attached and the tube section 9a, and communication is established between the fluid tube 4b and the tube section 9b. At this time, the fluid that has been existing since before the switching of the flowing direction stays in the prover pipe 2b and the tube section 9a in a fluid-tight fashion. Further, in the pipe section 9a, the sphere 5b, which has moved from the prover pipe 2b, is arranged in advance.

As the valve opening of the four-way valve 9c increases, the flow velocity of the fluid entering the tube section 9a increases gradually, until it finally attains a predetermined flow velocity, with the result that the sphere 5b, which exhibits the predetermined flow velocity along with the fluid, moves within the prover pipe 2b through the section between the two detectors 6b, 7b, and the measurement is performed, with the sphere 5b further reaching the tube section 9b.

In the next measurement, the four-way valve 9c is operated to establish communication between the fluid tube 3b and the tube section 9b and between the fluid tube 4b and the tube section 9a, introducing the fluid into the prover pipe 2b from the tube section 9b with the flowing direction being changed, whereby the measurement is effected through movement of the sphere 5b within the prover pipe 2b through the section between the two detectors 7b, 6b, with the sphere 5b reaching the tube section 9a.

Of the two types of reference volume tubes 1a and 1b described above, the former, i.e., the reference volume tube 1a, which is a unidirectional prover, involves a complicated apparatus structure due to the provision of the passage portion 8, whereas the latter, i.e., the reference volume tube 1b, which is a bidirectional prover, has no passage portion, which means the apparatus structure is so much the simpler.

### DISCLOSURE OF THE INVENTION

However, in the latter, i.e., the reference volume tube 1b, the operation of switching the four-way valve 9c requires a long time of, for example, more than 10 seconds.

Accurate measurement is impossible unless the reference volume tube is designed such that the sphere 5b causes the detector 6b or 7b to operate after the operation of switching the four-way valve 9c has been conducted and a state has been attained in which all the fluid having passed the flow meter to be tested flows in. In view of this, a distance of, for example, approximately 7.5 m is secured between the tube section 9a or 9b and the detector 6b or 7b (indicated by reference symbol 1 of FIG. 2), respectively, thus providing a sufficient runway.

That is, since the start of the inflow of the fluid into the tube section 9a or 9b, the sphere 5b moving within the tube section 9a or 9b, moves, after a run-up period indicated by reference symbol 1 of FIG. 2, through a predetermined section in the prover pipe 2b together with the fluid at a predetermined flow velocity. To be more specific, the requisite time for this fluid to attain the predetermined flow velocity corresponds, for example, to the requisite time for the four-way valve 9c to become half-open or totally open.

However, when the distance between the tube section and the detector is made larger as described above, the dimension of the reference volume tube in the longitudinal direction (horizontal direction of FIG. 2) becomes so much the larger, resulting, for example, in a problem of a rather large installation area for the reference volume tube.

A similar problem can be more or less involved not only in a reference volume tube in which a multi-way valve, such as a four-way valve, is used as the flow passage switching operation means, but also in a reference volume tube in which, for example, a plurality of single-way valves are arranged separately in the measurement tube portion of the apparatus so that they can exert a function similar to that of a four-way valve or the like.

The present invention has been made in view of the above problem. It is an object of the present invention to provide a reference volume tube, in which a moving element is caused to move within a prover pipe by a fluid, capable of achieving a reduction in the longitudinal dimension of the reference volume tube.

To achieve the object as described above, the reference volume tube according to the present invention, which is equipped with a measurement tube portion (volume tube) having a reference volume determined in a predetermined section and which calibrates a flow meter to be tested based on a volume of a fluid discharged when a moving element moves within the measurement tube portion through the predetermined section, is characterized by including a waiting means for causing the moving element to wait at a predetermined position on an upstream side of a start point of the predetermined section of the measurement tube portion.

Further, the reference volume tube according to the present invention is characterized in that the waiting means is a mechanical stopper for stopping the moving element.

In this case, the mechanical stopper may be composed of a pin to be engaged with the moving element and a hydraulic cylinder for biasing the pin.

Further, the reference volume tube according to the present invention is characterized in that: the reference volume tube is of a bidirectional prover type having a construction in which the fluid is movable bidirectionally within the measurement tube portion; both end portions of the measurement tube portion are respectively equipped with the waiting means; and the reference volume tube includes a multi-way valve, which is connected between the both end portions and the flow meter to be tested, for introducing the fluid into one of the both end portions through flow passage switching.

In this case, the measurement tube portion may be composed of a loop tube.

The reference volume tube according to the present invention has the waiting means for causing the moving element to wait at the predetermined position on the upstream side of the start point of a predetermined section of the measurement tube portion, so that, by canceling the stopping by the waiting means at the point in time when the flow direction has been completely switched, it is possible to cause the moving element to move at a predetermined flow velocity by the fluid. As a result, there is no need to provide a long runway as in the prior art, making it possible to reduce the longitudinal dimension of the reference volume tube, whereby it is possible, for example, to reduce an installation area for the reference volume tube. Further, it is also possible to form the reference volume tube as a portable one that can be mounted in a vehicle.

### BRIEF DESCRIPTION OF THE DRAWINGS

FIG. 1 is a schematic plan view of a conventional unidirectional prover-type reference volume tube.

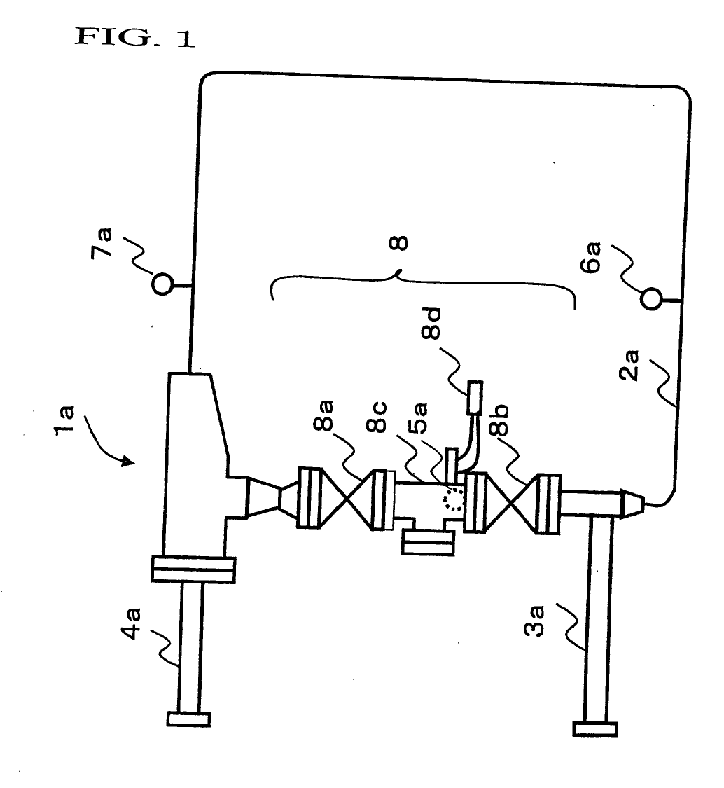

FIG. 2 is a schematic plan viewof a conventional bidirectional prover-type reference volume tube.

FIG. 3 is a schematic plan view of a reference volume tube according to an embodiment mode of the present invention.

### BEST MODE FOR CARRYING OUT THE INVENTION

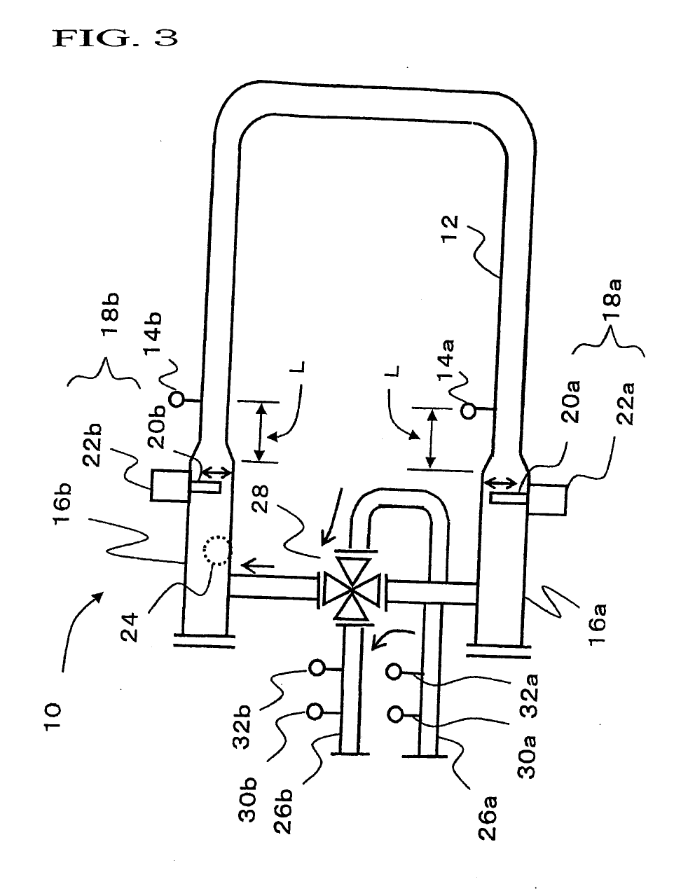

A reference volume tube according to a preferred embodiment of the present invention will be described below with reference to FIG. 3.

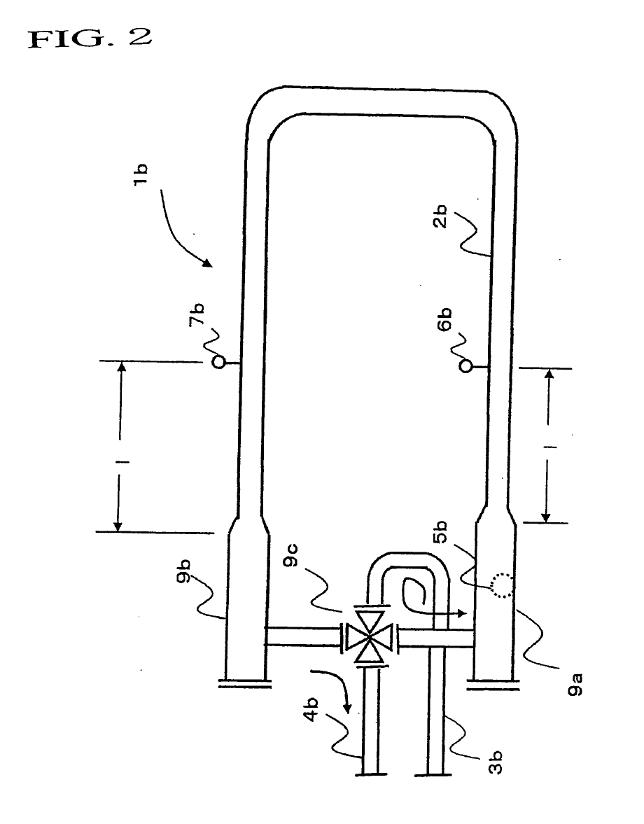

A reference volume tube 10 according to this embodiment mode, shown in FIG. 3, is a bidirectional prover of substantially the same basic construction as the conventional example shown in FIG. 2.

The reference volume tube 10 is equipped with a loop-tube-shaped measurement tube portion (hereinafter referred to as prover pipe) 12 having a reference volume. The prover pipe 12 is equipped with two detectors 14a, 14b. A volume defined by the section of the prover pipe 12 between the two detectors 14a, 14b constitutes the reference volume. The detectors 14a, 14b may be of an appropriate type, for example, mechanically operated electric switches, electronic proximity switches, or induction pick-ups may be used.

Tube sections 16a, 16b are provided at both ends of the prover pipe 12, and the distance between ends of the tube sections 16a, 16b and the detectors 14a, 14b (indicated by reference symbol L of FIG. 3) is substantially reduced as compared with that in the prior art. As in the conventional example, the diameter of the tube sections 16a, 16b is larger than that of the prover pipe 12.

Waiting means 18a, 18b are provided at the both ends of the prover pipe 12 and, in this case, on sides of the tube sections 16a, 16b nearer to the detectors 14a, 14b, that is, on upstream sides of the detectors 14a, 14b when the tube sections 16a, 16b are used as fluid inlet sides.

The waiting means 18a, 18b are mechanical stoppers, and are composed of pin-shaped gates 20a, 20b, and hydraulic cylinders 22a, 22b. The gates 20a, 20b are biased by the hydraulic cylinders 22a, 22b to radially protrude and retract within the tube sections 16a, 16b.

When a sphere 24, which constitutes a moving element, is situated in the tube section 16b as shown in FIG. 3, the gate 20b of the waiting means 18b provided between the sphere 24 and the detector 14b protrudes into the tube section 16b, whereby the sphere 24, which has moved from the tube section 16b toward the detector 14b, as shown in FIG. 3, is stopped by the gate 20b. Then, movement of the sphere 24 toward the detector 14b is prevented to be kept on standby at that position. On the other hand, when the gate 20b retracts toward the tube wall of the tube section 16b, the standby state of the sphere 24 is canceled.

Instead of the hydraulic cylinders 22a, 22b, the waiting means 18a, 18b can use electric cylinders, air cylinders, etc. as the driving portions. Further, they can use other appropriate driving means.

As long as the waiting means 18a, 18b have a function to stop the movement of the sphere 24 to keep it on standby at a predetermined position, some other mechanical stoppers may be used as the waiting means 18a, 18b. For example, it is possible to adopt a construction in which advancement of the sphere 24 is hindered by a plurality of pins, narrow plates, etc. protruding toward a radial center of the tube section 16b from the tube wall of the tube section 16b and in which the sphere 24 is allowed to advance by causing these pins, plates, etc. to fall over toward the tube wall. Further, as the waiting means 18a, 18b, it is also possible to use appropriate electric or electronic means.

Fluid tubes 26a, 26b, which are used as either inlet tubes or outlet tubes through switching of the flow passages, and the two tube sections 16a, 16b are connected by a four-way valve 28 so as to allow flow passage switching.

In FIG. 3, temperature gauges for measuring fluid temperature is denoted by reference symbols 30a, 30b, and indicate pressure gauges for measuring fluid pressure is denoted by reference symbols 32a, 32b.

A flow meter to be tested (not shown) is connected to one of the fluid tubes 26a, 26b, for example, the fluid tube 26a. That is, the flow meter to be tested is connected in series with the reference volume tube 10 through the fluid tube 26a.

Mounted to the flow meter to be tested is a pulse transmitter (not shown) adapted to generate and transmit pulses in a number in proportion to the flow rate.

The pulse signals from this pulse transmitter and detection signals (start/stop signals) from the detectors 14a, 14b are taken in by a measurement CPU (proving computer) (not shown). On the other hand, control signals are transmitted to the four-way valve 28 and the hydraulic cylinders 22a, 22b from a control CPU (flow computer) (not shown). Further, an opening signal of the four-way valve 28 is transmitted to the control CPU. The four-way valve 28 and the hydraulic cylinders 22a, 22b may be of a type which are manually operated.

In the state shown in FIG. 3, the fluid from the fluid tube 26a has been caused to flow from the tube section 16a to the tube section 16b to complete the measurement, with the sphere 24 having moved counterclockwise within the prover pipe 12 before reaching the tube section 16b to stay there.

When starting the next measurement, the four-way valve 9c is operated by the control signal of the control CPU to establish communication between the fluid tube 26a and the tube section 16b and between the fluid tube 26b and the tube section 16a, thereby reversing the flowing direction of the fluid in the reference volume tube 10. As stated above, at this time, the sphere 24 has been previously arranged in the tube section 16b. Further, on the upstream side of the sphere 24, the gate 20b has been lowered to attain the closed state by the control signal of the control CPU.

By starting the operation of the four-way valve 9c, the fluid having passed through the flow meter to be tested begins to flow into the tube section 16b from the fluid tube 26a. When the sphere 24 is caused to move to the position of the gate 20b by the fluid, which has not attained the predetermined flow velocity, the sphere 24 is engaged with the gate 20b and stopped at that position to be placed in a standby state. At the same time, the fluid flows into the prover pipe 12 through a gap between the sphere 24 and the tube section 16b.

When the fluid attains the predetermined flow velocity, a signal indicating, for example, that the four-way valve 9c has attained a predetermined opening degree (normal, totally open) is received, and the gate 20b is opened by the control signal of the control CPU, thus canceling the standby state of the sphere 24. The sphere 24 passes through the prover pipe 12 together with the fluid, which attained a predetermined flow velocity. Here, instead of using information on the valve opening degree of the four-way valve 9c as described above, it is also possible to use information on a length of the time that has elapsed since the valve operation start, the flow velocity (or the flow rate) at the flow meter to be tested, etc. as means for making a judgment as to whether the flowing direction of the fluid has been reliably changed and a predetermined flow velocity has been reached.

The detection signals from the detectors 14a, 14b and the pulse signals from the pulse transmitter of the flow meter to be tested when the sphere 24 passes, are taken in by the measurement CPU.

Then, the measurement CPU measures the number of pulses from the pulse transmitter from the moment at which the detection signal of the detector 14b is obtained until the moment at which the detection signal of the detector 14a is obtained. Through the movement of the sphere 24 through the section between the two detectors 14a, 14b, a reference volume is indicated, so that, by comparing this reference volume with the indication value (volume) of the flow meter to be tested obtained from the number of pulses as measured, any error of the flow meter to be tested is measured, and further calibration is effected as needed. Instead of the pulse signals, it is also possible to use, for example, an analog signal corresponding to a voltage obtained in correspondence with the flow rate. It is also possible to use the same CPU both as the control CPU and the measurement CPU.

In this embodiment mode described above, the waiting means 18a, 18b are provided in the tube sections 16a, 16b. Instead, it is also conceivably possible to provide the waiting means 18a, 18b at the ends of the prover pipe 12. That is, by providing the waiting means 18a, 18b at the both ends of the prover pipe 12, that is, on the upstream side of the detectors 14a, 14b, it will be possible to omit the tube sections 16a, 16b, making it possible to achieve a further reduction in the size of the reference volume tube 10.

In this case, the sphere 24 being kept on standbyby the waiting means 18a, 18b, serves, so to speak, as a valve provided on the upstream side of the four-way valve 9c, and the sphere 24 cuts off the flow of the fluid until the four-way valve 9c attains the predetermined opening degree. At the point in time when the four-way valve attains the predetermined opening degree, the lock by the waiting means 18a, 18b is released, and the sphere 24 moves together with the fluid, which flows at the predetermined flow velocity. In this case, in order to secure the fluid flow in the opposite direction prior to the start of the next measurement with the flowing direction of the fluid changed, some contrivance is needed; for example, it is necessary to provide a discharge tube for discharging the fluid in each of the portions constituting the runways between the waiting means 18a, 18b and the detectors 14a, 14b. This discharge tube is closed during the next measurement.

In this case, however, there is inevitably involved, though short, a change from a state in which the flow velocity of the fluid is zero to the state in which the predetermined flow velocity has been attained, during an initial period in which the sphere 24 starts to move through releasing of the waiting means 18a, 18b. That is, although the requisite time for the predetermined flow velocity of the fluid to be reached is shortened as compared with the prior art, it does not mean this period of time is completely eliminated. Thus, it is to be assumed that, unlike the above-described embodiment mode, this construction does not completely eliminate the problem in the prior art but still involves a deterioration in measurement accuracy.

In the above-described embodiment mode, it is also possible to use, instead of a tube with a circular sectional configuration, a tube with a sectional configuration that is elliptical, rectangular, etc., using a moving element of a configuration in conformity with such sectional configuration of the tube. Further, instead of a loop tube, it is also possible to use a straight tube as the prover pipe 12. Further, instead of being arranged on the upstream side of the prover pipe 12, the flow meter to be tested may also be arranged on the downstream side of the prover pipe 12.

Further, the present invention is not restricted to the above-described embodiment mode but is also applicable, for example, to a unidirectional prover-type reference volume tube which is provided with no flow passage switching structure and which performs test by causing fluid to flow only in one direction.

1. A reference volume tube which is equipped with a measurement tube portion having a reference volume determined in a predetermined section and which calibrates a flow meter to be tested based on a volume of a fluid discharged when a moving element moves within the measurement tube portion through the predetermined section,
the reference volume tube being characterized by comprising a waiting means for causing the moving element to wait at a predetermined position on an upstream side of a start point of the predetermined section of the measurement tube portion.

2. A reference volume tube according to claim 1, characterized in that the waiting means is a mechanical stopper for stopping the moving element.

3. A reference volume tube according to claim 2, characterized in that the mechanical stopper is composed of a pin to be engaged with the moving element and a hydraulic cylinder for biasing the pin.

4. A reference volume tube according to claim 1, characterized in that:
the reference volume tube is of a bidirectional prover type having a construction-in which the fluid is movable bidirectionally within the measurement tube portion;
both end portions of the measurement tube portion are respectively equipped with the waiting means; and the reference volume tube comprises a multi-way valve, which is connected between the both end portions, and the flow meter to be tested, for introducing the fluid into one of the both end portions through flow passage switching.

5. A reference volume tube according to claim 4, characterized in that the measurement tube portion is a loop tube.
